(19) United States
(12) Patent Application Publication
(10) Pub. No.: US 2007/0088989 A1
(43) Pub. Date: Apr. 19, 2007

(54) Method for dynamically choosing between varying processor error resolutions

(76) Inventors: Christopher M. Abernathy, Austin, TX (US); A. James Van Norstrand JR., Round Rock, TX (US); David Shippy, Austin, TX (US); Hiroo Hayashi, Tokyo (JP); Masaki Osawa, Tokyo (JP)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/252,398

(22) Filed: Oct. 18, 2005

(51) Int. Cl. G06F 11/00

(52) U.S. Cl. 714/48

(57) ABSTRACT

A method of processor error resolution includes receiving a resource error alert at a processor, determining an application error resolution preference at the processor, and executing an algorithm corresponding to the error resolution preference at the processor. Another embodiment provides a method for providing an error resolution preference from an application to a processor including receiving a resource error notification at an application, and sending one of at least two application error resolution preferences to a processor based on the resource error notification. Another embodiment is a system for providing an error resolution preference from an application to a processor that includes means for sending an application error resolution preference to a processor based on a resource error notification, means for determining the application error resolution preference at the processor, and means for executing the error resolution preference at the processor.

### FIELD OF INVENTION

The present invention generally relates to computer and processor architecture. More specifically, the invention relates to dynamically choosing a processor algorithm through software instructions.

### BACKGROUND OF THE INVENTION

Presently, manufacturers of microprocessors must choose between one of several algorithms to incorporate into a microprocessor to perform functions such as addressing an unavailable resource error. For example, FIGS. 1A and 1B illustrate two behaviors a microprocessor manufacturer can choose to implement when a load instruction misses an L1 data cache and causes a flush. L1 data cache ‘misses’ occur when a load instruction's data is not found in the cache. A first method 101 flushes all instructions after the load. A second, more complex but with improved performance in some respects, method 102 flushes all instructions beginning at the first instruction that actually depends upon the load that ‘missed’. This allows instructions after the load that ‘missed’ (including additional load/store instructions) to be executed up until a ‘load-miss-dependency’ is encountered.

Method 101 illustrates one embodiment of a re-flush algorithm and begins at step 111. When an operation attempts to load data from memory, the data is first looked for in the L1 data cache in step 121. If the data is not available, the operations behind the load are flushed at step 131. The next operation can then be re-fetched at step 141. The next operation is issued again at step 151, and if the load data is still not available in step 121 (not in the L1 data cache yet) then the operation returns to be flushed yet again at step 131 (or repeatedly, until the data is in the L1 data cache). Method 101 ends at step 191.

Method 102 illustrates one embodiment of a re-issue algorithm and begins at step 112. When an operation attempts to load data from memory, the data is first looked for in the L1 data cache in step 122. If the data is not available, it is then determined in step 124 whether the next instruction is dependent on the missing data. If the next instruction is not dependent on the missing data, the instruction executes normally in step 126 and the algorithm returns to the beginning of step 124 to determine the next instruction's ability to execute. If the next instruction is dependent on the missing data, the operation is flushed at step 132 as implemented in step 131. The operation is then be re-fetched at step 142 as implemented in step 141. The operation that is flushed is re-issued at step 152 as implemented in step 151. Method 102 ends at step 192.

Typically, manufacturers must choose between a more efficient, complex algorithm, such as method 102, and a less efficient, simple algorithm, such as method 101. As a result, when implementing a processor based application, a designer must choose a processor incorporating an efficient algorithm, a processor incorporating a simple algorithm, or the added cost of choosing both. The problem is compounded because various software applications may be written to respond better to one algorithm versus another.

Another possible method for handling data cache misses involves stalling the program immediately and waiting for the data to become available in the cache. This “stall” algorithm is a relatively simple method for handling data cache misses. However, it would be advantageous, under some circumstances, for a single thread program to use a stall method instead of a more complicated algorithm.

It is desired to advance the art.

### SUMMARY OF THE INVENTION

One embodiment of the present invention is a method of processor error resolution. The method includes receiving a resource error alert at a processor, determining an application error resolution preference at the processor, and executing the algorithm corresponding to the error resolution preference at the processor.

Another embodiment of the present invention is method of providing an error resolution preference from an application to a processor. The method includes receiving a resource error notification at an application; and sending one of at least two application error resolution preferences to a processor based on the resource error notification.

Yet another embodiment of the present invention is a system for providing an error resolution preference from an application to a processor. The system includes a means for sending one of at least two application error resolution preferences to a processor based on a resource error notification, a means for determining the application error resolution preference at the processor, and a means for executing the error resolution preference at the processor.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

The foregoing and other objects, advantages, and features of the present invention will be apparent from the following detailed description and the accompanying drawings, in which:

FIGS. 1A and 1B illustrate two methods of a cache flushing by a processor employing level 1 and level 2 caching (prior art);

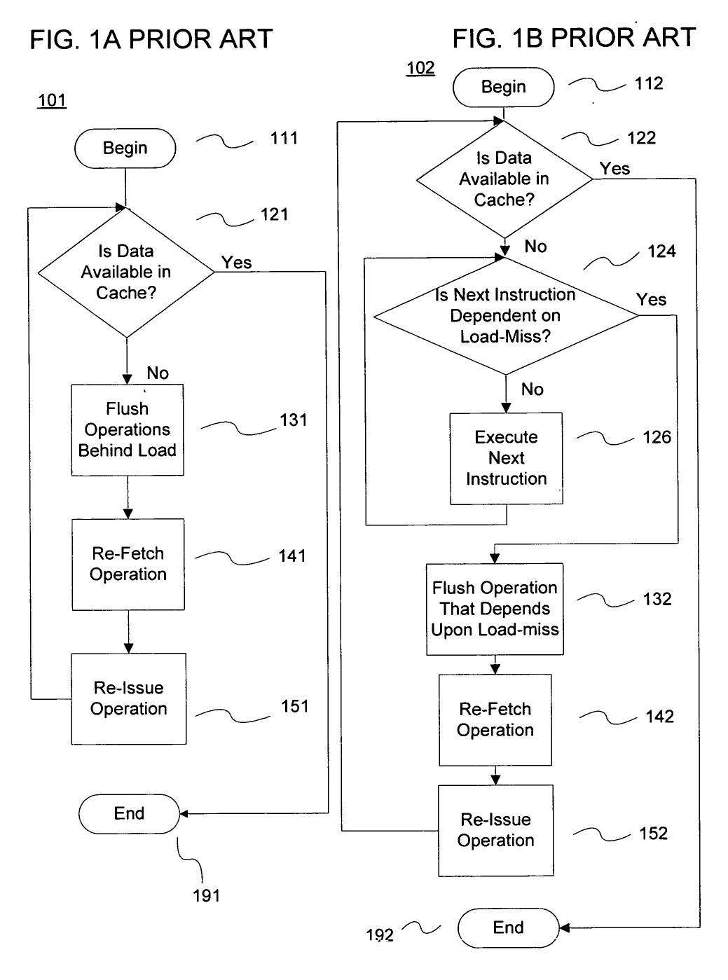

FIG. 2 illustrates a flowchart of one embodiment of a method for processor error resolution in accordance with one aspect of the invention;

FIG. 3 illustrates a flowchart of another embodiment of a method for processor error resolution in accordance with one aspect of the invention;

FIG. 4 illustrates a flowchart of a one embodiment of a method for providing an error resolution preference from an application to a processor in accordance with one aspect of the invention;

FIG. 5 illustrates a flowchart of another embodiment of a method for providing an error resolution preference from an application to a processor in accordance with one aspect of the invention;

FIG. 6 illustrates a flowchart of another embodiment of a method for providing an error resolution preference from an application to a processor in accordance with one aspect of the invention;

FIG. 7 illustrates a flowchart of another embodiment of a method for providing an error resolution preference from an application to a processor in accordance with one aspect of the invention; and

FIG. 8 illustrates a system for providing an error resolution preference in accordance with one aspect of the invention.

### DETAILED DESCRIPTION OF THE PRESENT INVENTION

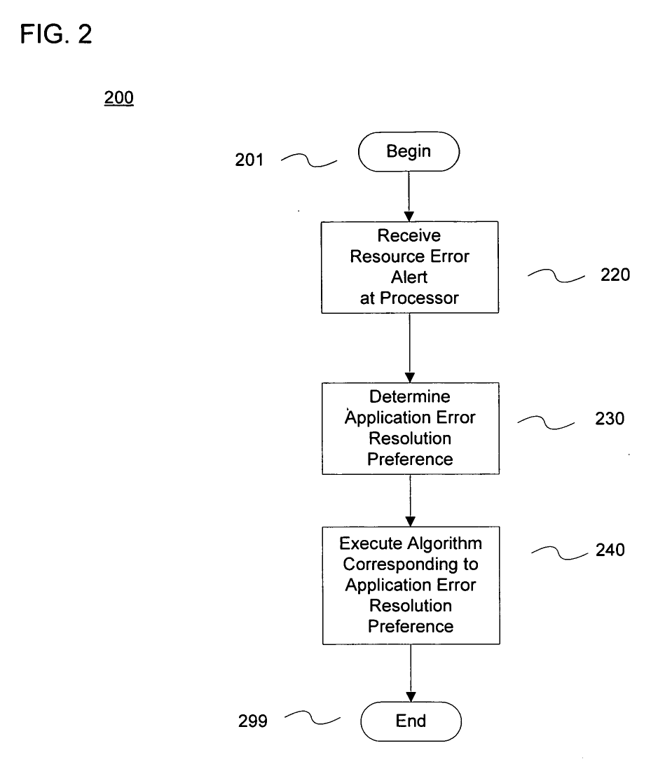

FIG. 2 illustrates a flowchart of one embodiment of a method 200 for processor error resolution in accordance with one aspect of the invention. Method 200 begins at step 201.

A resource error alert is received at the processor in step 220. A resource error alert occurs when the processor attempts to use or access a resource and the resource is unavailable at that time. For example, a resource is any ‘queue’ unavailable at execution time. In one embodiment of the present invention, the resource is L1 cache data and a resource error alert occurs when the L1 cache does not contain data requested by the processor. In another embodiment, the resource is a conditional register (CR), and a resource error alert results from a failure to complete an instruction, potentially as a result of a relatively lengthy latency common to CR registers. In yet another embodiment, the resource is within the processor itself. For example, when an architectural flaw in the processor prevents the processor from operating as intended, a resource error alert occurs. In yet another embodiment, the resource is a state machine that is ‘busy.’

The processor determines an application error resolution preference in step 230. In one embodiment of the present invention, the determination in step 230 is responsive to the resource error alert in step 220. In another embodiment, the determination of an application error resolution preference in step 230 is independent of the resource error alert in step 220. In one embodiment of the present invention, the application error resolution preference is one or more bits representing the choice of algorithms for the processor to run in response to the resource error. In one embodiment, the application error resolution preference is loaded based on an initial execution of the application. In another embodiment, the application error resolution preference is loaded based on a boot of the system.

The processor executes the algorithm corresponding to the error resolution preference in step 240. In one embodiment of the present invention, the algorithm is one of multiple cache data retrieval algorithms in the processor. For example, the processor is capable of running either a cache data retrieval algorithm that re-flushes the cache on a cache miss, or a cache data retrieval algorithm that re-issues the operation that caused the cache miss. In another embodiment of the present invention, the processor is capable of running more than two possible cache data retrieval algorithms. For example, the processor could be designed to include the data retrieval algorithms above, as well as a stall algorithm that waits until the data is available. The processor executes whichever cache data retrieval algorithm in step 240 that corresponds to the application error resolution preference from step 230.

In another embodiment, the algorithm executed in step 240 is a latent register data algorithm. A latent register data algorithm is an error resolution called when an instruction depends on a register value that has not been updated yet from a previous instruction. In yet another embodiment, the algorithm executed in step 240 is a state machine busy algorithm where a state machine is a resource currently busy and unavailable.

Method 200 ends at step 299.

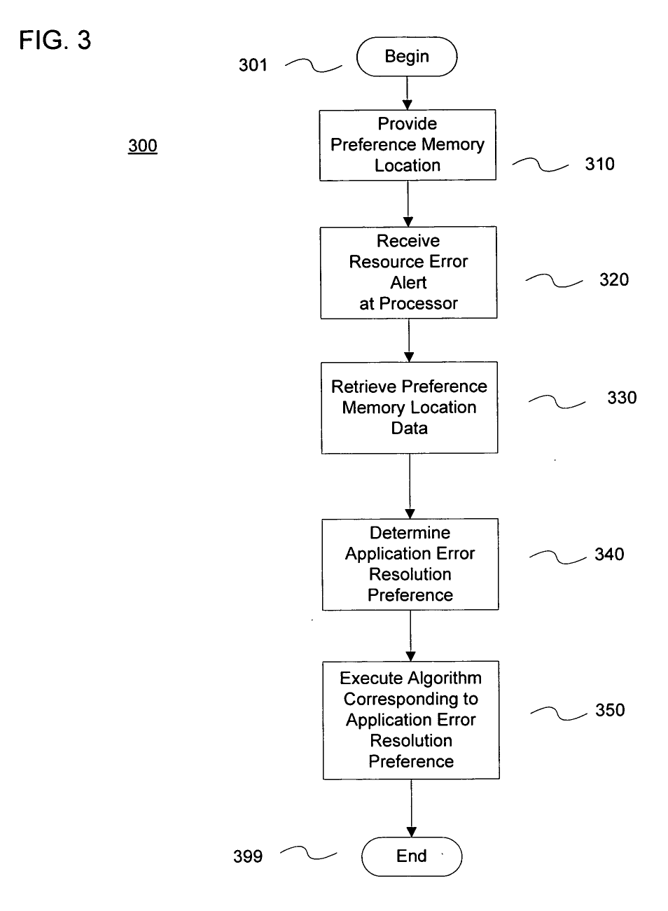

FIG. 3 illustrates a flowchart of another embodiment of a method 300 for processor error resolution in accordance with one aspect of the invention. Method 300 begins at step 301.

A preference memory (PM) location is provided in step 310. In one embodiment of the invention, the PM location is a permanent processor register containing at least one bit. In other embodiments, forms of memory including buffers, RAM, ROM, or peripheral devices are configured to act as the PM location. In one embodiment of the present invention, the PM location is a single bit set to one or zero corresponding to two possible algorithms the processor is capable of running. In other embodiments of the invention, the number of bits in the PM location is increased to accommodate more than two possible algorithms.

The processor receives a resource error alert during step 320. In one embodiment, step 320 is implemented as in step 220.

The processor retrieves data stored in the PM location in step 330. In one embodiment, the processor reads the data from the PM location before each program thread. In another embodiment, the PM location is checked each time the processor must run one of the possible algorithms associated with the resource error alert in step 320.

An application error resolution preference is determined at step 340. In one embodiment, step 340 is implemented as in step 230.

The algorithm corresponding to the application error resolution preference is executed at step 350. In one embodiment, step 350 is implemented as in step 240.

Method 300 ends at step 399.

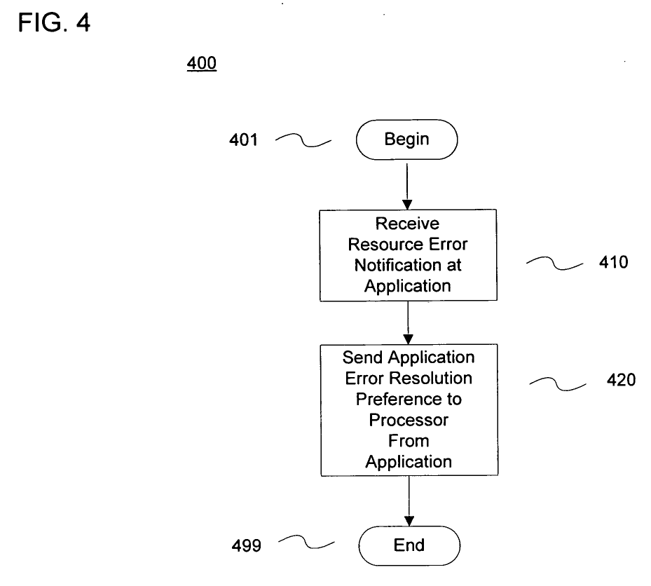

FIG. 4 illustrates a flowchart of one embodiment of a method 400 for providing an error resolution preference from an application to a processor. Method 400 begins at step 401.

The application receives a resource error notification in step 410. In one embodiment, the processor sends the resource error notification after the processor receives a resource error alert. For example, the processor sends the resource error notification based on receiving a resource error alert, as in step 220.

The application sends one of at least two application error resolution preferences to the processor in step 420. In one embodiment of the present invention, the application stores the application error resolution preference in a PM location. For example, the PM location is a register containing at least one bit.

In another embodiment, the application includes a preference instruction set compatible with the processor. The preference instruction set includes assembly language opcodes for writing a value to the PM location and for reading the value from the PM location.

In another embodiment of the present invention, the preference instruction set includes at least one additional opcode, such as latching the value in the PM location and resetting the PM location to a default value.

In yet another embodiment of the present invention, the preference instruction set includes an opcode for enabling all preference instruction set opcodes and an opcode to disable all preference instruction set opcodes except for the enable opcode.

Method 400 ends at step 499.

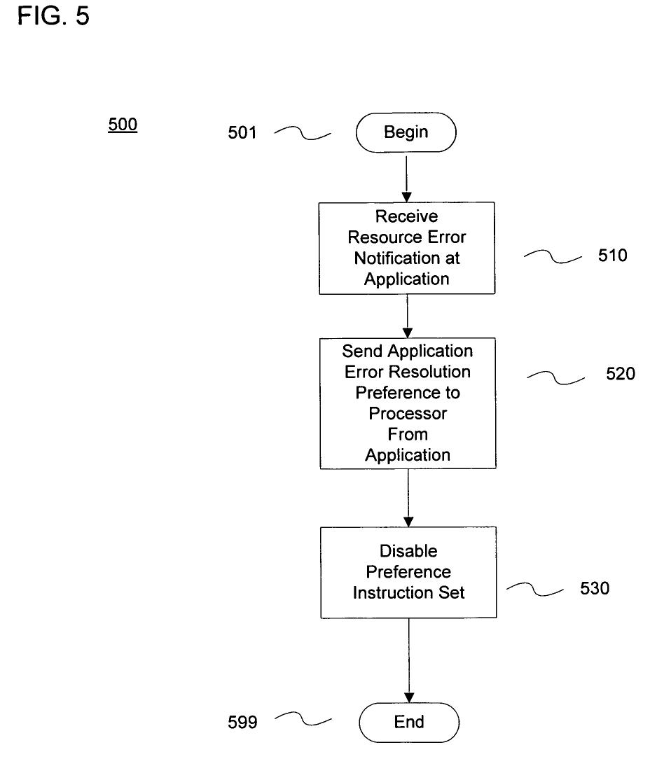

FIG. 5 illustrates a flowchart of another embodiment of a method 500 for providing an error resolution preference from an application to a processor. Method 500 begins at step 501.

The application in step 510 receives a resource error notification where the resource error is an internal processor error. The application includes a preference instruction set compatible with the processor. In one embodiment, the preference instruction set includes an opcode to enable the entire preference instruction set, and an opcode to disable the entire preference instruction set except the enable opcode. In one embodiment of the present invention, the application is a Basic Input/Output System (BIOS). In one embodiment, the resource error notification is received as part of an upgrade or patch to the application. For example, an upgrade or patch issued due to an architectural flaw internal to the processor includes a resource error notification.

An application error resolution preference is sent to the processor in step 520. In one embodiment of the present invention, the application error resolution preference is a permanent solution to an architectural flaw internal to the processor. In the embodiment, the application error solution preference corresponds to a non-flawed algorithm.

The preference instruction set is disabled in step 530. The preference instruction set is disabled to prevent other applications from sending different application error resolution preferences since the resource error in step 510 is an internal flaw in the processor and the upgrade or patch issued in step 510 was issued to prevent access to a flawed algorithm.

Method 500 ends at step 599.

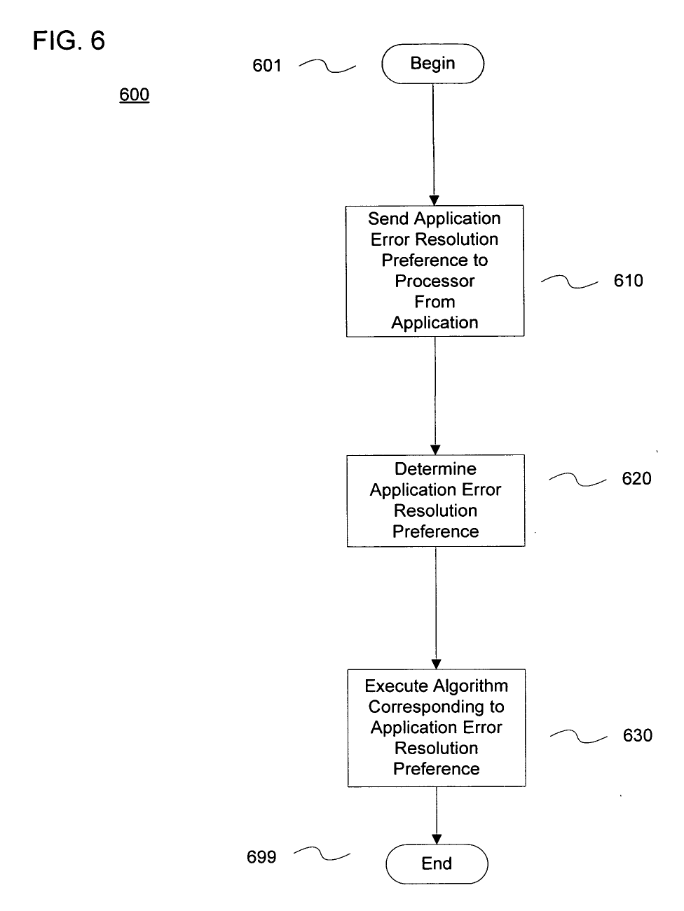

FIG. 6 illustrates a flowchart of another embodiment of a method 600 for providing an error resolution preference from an application to a processor. Method 600 begins at step 601.

The application sends an application error resolution preference to the processor at step 610. In one embodiment, step 610 is implemented as in step 420.

The application error resolution preference is determined at step 620. In one embodiment, step 620 is implemented as in step 230.

The processor executes the algorithm corresponding to the application error resolution preference at step 630. In one embodiment, step 630 is implemented as in step 240.

Method 600 ends at step 699.

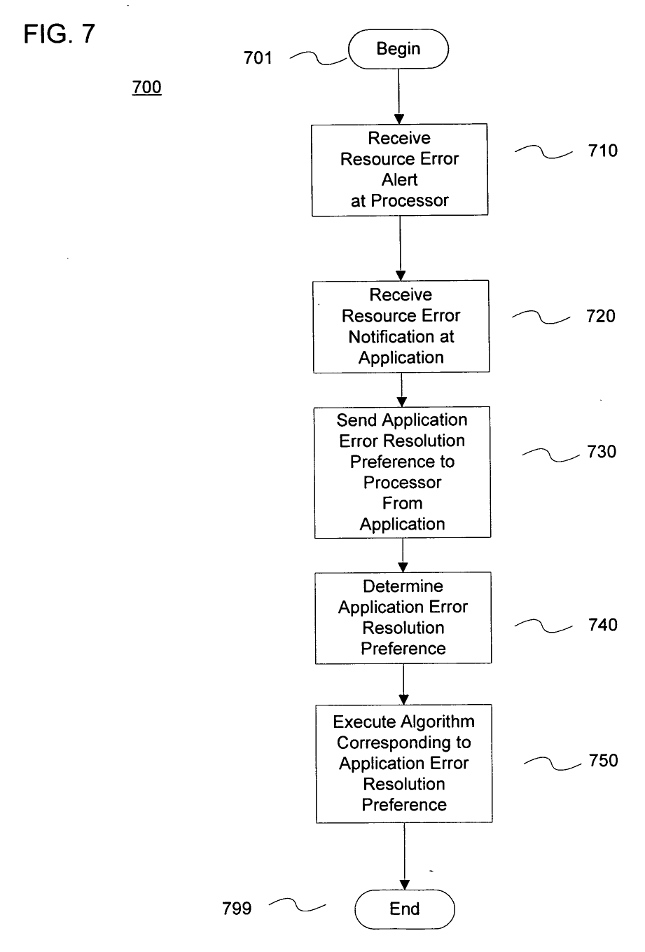

FIG. 7 illustrates a flowchart of another embodiment of a method 700 for providing an error resolution preference from an application to a processor. Method 700 begins at step 701.

The processor receives a resource error alert at step 710. In one embodiment, step 710 is implemented as in step 220.

The application receives a resource error notification at step 720. In one embodiment, step 720 is implemented as in step 410.

The application sends the application error resolution preference to the processor at step 730. In one embodiment, step 730 is implemented as in step 420.

The processor determines the application error resolution preference at step 740. In one embodiment, step 740 is implemented as in step 230.

The processor executes the algorithm corresponding to the application error resolution preference at step 750. In one embodiment, step 750 is implemented as in step 240.

Method 700 ends at step 799.

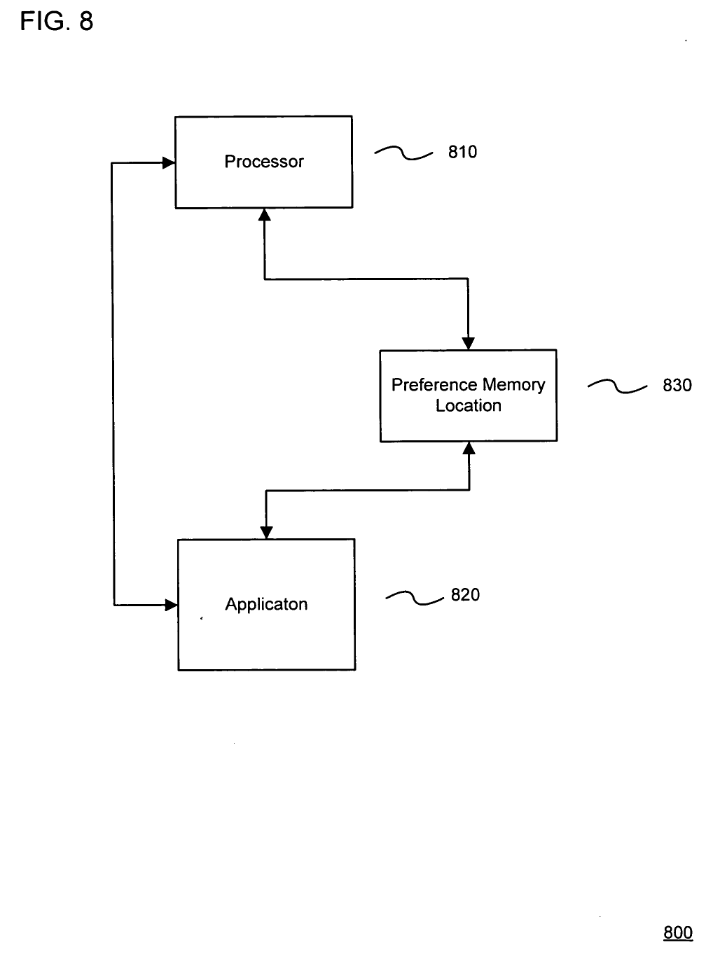

FIG. 8 illustrates a block diagram of one embodiment of a system 800 for providing an error resolution preference from an application to a processor.

System 800 includes a processor 810 and an application 820. Processor 810 is any computer device configured to sequentially perform instructions, and application 820 is any computer-readable listing of commands to obtain a desired result or effect.

In one embodiment of the invention, application 820 includes a means for receiving a resource error notification. In one example, the application receives the resource error notification from the processor 810. The processor sends the resource error notification following receipt of a resource error alert at the processor. In another example, the application 820 receives a resource error notification from an application upgrade or patch.

In one embodiment of the present invention, the system also includes a means for the application 820 to send one of at least two application error resolution preferences to the processor 810 based on a resource error notification. In one example, the application stores the application error resolution preference in the preference memory location 830. In another embodiment, the application 820 also includes a means for disabling the capability to send an application error resolution preference to the processor 810.

Processor 810 includes a means for determining the application error resolution preference. In one embodiment, processor 810 reads the application error resolution preference from the preference memory location 830.

Processor 810 also includes a means for executing an algorithm corresponding to the application error resolution preference.

Embodiments of the present invention can include many different types of architectural functions within a processor when a particular resource is not available. Those skilled in the art will recognize when a processor can execute multiple possible algorithms after flushing because of a lack of resource, an embodiment of the present invention provides a method to allow incorporating all algorithms into the processor and the ability for software to choose a best fit algorithm.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A method of processor error resolution, the method comprising:
receiving a resource error alert at a processor;
determining an application error resolution preference at the processor; and
executing an algorithm corresponding to the error resolution preference at the processor.

2. The method of claim 1 wherein the determination is responsive to the resource error alert.

3. The method of claim 1 further comprising:
providing a preference memory location;
retrieving the application error resolution preference from the preference memory location.

4. The method of claim 3 wherein the preference memory location is a register containing at least one bit.

5. The method of claim 1 wherein the algorithm corresponding to the error resolution preference is selected from the group consisting of: cache data retrieval algorithms, latent conditional register algorithms, and state machine busy algorithms.

6. The method of claim 5 wherein the cache data retrieval algorithms are selected from the group consisting of: a reflush instruction and a re-issue instruction.

7. The method of claim 1 wherein the resource error alert is received after an event selected from the group consisting of: an L1 data cache load miss, a state machine busy condition, and a conditional register (CR) update error.

8. A method of providing an error resolution preference from an application to a processor, the method comprising:
receiving a resource error notification at an application; and
sending one of at least two application error resolution preferences to the processor based on the resource error notification.

9. The method of claim 8 wherein the application error resolution preference comprises a preference instruction set for storing and retrieving the application error resolution preference in the preference memory location.

10. The method of claim 8 wherein sending one of at least two application error resolution preferences comprises storing the error resolution preference in a preference memory location.

11. The method of claim 8 wherein the preference memory location is a register containing at least one bit.

12. The method of claim 8 wherein the resource error notification is received after an event selected from the group consisting of: an L1 data cache load miss and a conditional register (CR) update error.

13. The method of claim 8 wherein the application is a Basic Input/Output System (BIOS).

14. The method of claim 8 wherein the resource error is an internal processor error.

15. The method of claim 9 further comprising sending an instruction for disabling the preference instruction set to an application.

16. The method of claim 9 further comprising sending an instruction for enabling the preference instruction set.

17. A system for providing an error resolution preference from an application to a processor comprising:
means for receiving a resource error notification at the application;
means for sending one of at least two application error resolution preferences to a processor based on a resource error notification;
means for determining the application error resolution preference at the processor; and
means for executing an algorithm corresponding to the application error resolution preference at the processor.

18. The system of claim 17 further comprising means for disabling the means for sending one of at least two application error resolution preferences to the processor.
